(19) United States
(12) Patent Application Publication
(10) Pub. No.: US 2017/0199301 A1
(43) Pub. Date: Jul. 13, 2017

(54) BIOFOULING REMOVAL MECHANISM

(71) Applicant: CGG SERVICES SAS, Massy Cedex (FR)

(72) Inventors: Erik ORNES, Oslo (NO); Raphael MACQUIN, Montrouge (FR); Alexandre PETRIGNY, Forges les Bains (FR)

(21) Appl. No.: 15/316,699

(22) PCT Filed: Jun. 10, 2015
(86) PCT No.: PCT/IB2015/001179

§ 371 Date: Dec. 6, 2016

Related U.S. Application Data
(60) Provisional application No. 62/084,126, filed on Nov. 25, 2014.
(60) Provisional application No. 62/053,249, filed on Sep. 22, 2014.
(60) Provisional application No. 62/010,474, filed on Jun. 11, 2014.

(51) Int. Cl. G01V 13/00; B08B 9/023

(52) U.S. Cl. CPC G01V 13/00; B08B 9/023; E02B 17/0034

(57) ABSTRACT

A biofouling removal mechanism includes at least one cleaning element configured to remove accumulated biofouling from a structure and a cleaning element support structure attached to the cleaning element. The cleaning element support structure is configured to secure the cleaning element to the structure, to guide the cleaning element along the structure and to accommodate changes in at least one of a size and a shape of the structure as the cleaning element passes along the structure.

### CROSS REFERENCE TO RELATED APPLICATIONS

This application claims priority and benefit from U.S. Provisional Patent Application Nos. 62/010,474, filed Jun. 11, 2014, for “Barnacle Cleaning Tool”, 62/053,249, filed Sep. 22, 2014 for “Foldable Compact Cleaning Tool” and 62/084,126, filed Nov. 25, 2014 for “Cutting Cleaning Modules”, the entire contents of which are incorporated herein by reference.

### TECHNICAL FIELD

Embodiments of the subject matter disclosed herein generally relate to biofouling removal, more particularly, to removing barnacles and algae from cables.

### BACKGROUND

Objects and structures exposed to aquatic or marine environments for extended periods of time will accumulate biofouling. This biofouling includes plant and animal life such as algae and barnacles, e.g., Conchoderma Auritum, conchoderma virgatum, lepas anatifera, balanus amphitrite. The biofouling interferes with the normal operation of the structures to which it attaches and presents problems including added weight, surface damage and increased drag. Therefore, accumulated biofouling must be removed or cleaned from the structures to which it attaches on a regular if not continuous basis.

Seismic surveys conducted in a marine environment utilize towed streamers that include long runs of cable deployed in the marine environment and towed behind a vessel. As a marine seismic survey is conducted over long periods of time, the long runs of cable constitute the structures on which the biofouling accumulates. Conventional methods cannot adequately remove both soft biofouling accumulations, for example, juvenile barnacles and algae, and hard biofouling accumulations, for example, adult barnacles (lepas anatifera).

In addition, the streamers are not merely long runs of cable. Included along the length of the streamers are structures such as weights, sensors and depth and lateral controllers, e.g., Nautilus birds and retriever. These structures change the shape and cross sectional area of the streamer and present large obstacles along the length of the cable. Tools passing along the length of the cable contact these additional structures. Therefore, barnacle cleaning tools are desired that can reliably remove both soft and hard biofouling accumulations along an entire length of a streamer cable while accommodating additional structures located along this length. The barnacle cleaning tool will be usable in situ, during deployment of the seismic streamer or during retraction of the seismic streamer.

### SUMMARY

Exemplary embodiments are directed to a biofouling removal mechanism that includes at least one cleaning element configured to remove accumulated biofouling from a structure and a cleaning element support structure attached to the cleaning element. The cleaning element support structure is configured to secure the cleaning element to the structure, to guide the cleaning element along the structure and to accommodate changes in at least one of a size and a shape of the structure as the cleaning element passes along the structure.

In one exemplary embodiment of a biofouling removal mechanism, at least one cleaning element is configured to remove accumulated biofouling from a structure and is attached to a cleaning element support structure. The cleaning element support structure is configured to guide the cleaning element along the structure to be cleaned and to accommodate changes in the geometry of the structure as the cleaning element passes along the structure. In one embodiment, the cleaning element is an edge tool. Alternatively, the cleaning element includes a plurality of circular cleaning scrapers arranged co-axially, and each one of the circular cleaning scrapers has a unique diameter. In one embodiment, the cleaning element has a leading edge configured to curve away from the structure to guide the cleaning element over changes in the size and shape of the structure.

In one embodiment, the cleaning element support structure includes a protective element to prevent contact between the cleaning element and the structure and to establish a pre-defined spacing between the cleaning element and the structure. This protective element includes a plurality of parallel lines spaced from each other and extending in a direction in which the cleaning element passes over the structure. In one embodiment, the cleaning element support structure includes a biasing member to bias the cleaning element toward the structure.

In one embodiment, the cleaning element support structure is a helical structure with the cleaning element disposed in an interior of the helical structure. At least one strut is provided in contact with the helical structure and the cleaning element to position the cleaning element in the interior of the helical structure. In another embodiment, the cleaning element support structure is a foldable structure having a folded position for attachment to the biofouling removal mechanism to the structure and an expanded position to accommodate the changes in the geometry of the structure. Alternatively, the cleaning element support structure is an inflatable structure. The cleaning element support structure can also include at least one of ballast, a buoy and a propulsion mechanism to drive the biofouling removal mechanism along the structure. The propulsion mechanism includes at least one of a drag canopy and a propulsion motor.

In one embodiment, the cleaning element support structure includes a cleaning element motor in communication with the cleaning element to move the cleaning element relative to the cleaning element support structure. In another embodiment, the cleaning element support structure has a hollow conical housing with a plurality of sections. The cleaning element is attached to an interior of the hollow conical housing. At least one elastic band passes completely around the hollow conical housing on an exterior of the hollow conical housing opposite the interior.

Another exemplary embodiment is directed to a method for removing biofouling from seismic equipment such as all of the portions of a seismic streamer. In this method, a biofouling removal mechanism is attached to the seismic equipment. The biofouling removal mechanism can be attached at a towing vessel that is pulling the seismic equipment or from a service boat separate from a towing vessel that is pulling the seismic equipment with the seismic equipment located below a surface of a body of water.

The structure of the biofouling removal mechanism is used to propel the biofouling removal mechanism along an entire length of the seismic equipment while removing biofouling and accommodating all changes in a geometry of the seismic equipment. These changes in the geometry of the seismic equipment include changes in a diameter of the seismic equipment, joints, weights, floats, spreader ropes between streamer cables, ropes and chains used to attach floats, wings and radial projections. Using the structure of the biofouling removal mechanism further includes rotating the biofouling removal mechanism having a helical structure to pass portions of the seismic equipment associated with the changes in the geometry of the seismic equipment through windings in the helical structure. Alternatively, using the structure of the biofouling removal mechanism involves expanding a folding structure of the biofouling removal mechanism to a size and shape sufficient to pass portions of the seismic equipment associated with the changes in the geometry of the seismic equipment through an expanded folding structure. In another embodiment, using a structure of the biofouling removal mechanism includes inflating an inflatable structure of the biofouling removal mechanism to a size sufficient to pass portions of the seismic equipment associated with the changes in the geometry of the seismic equipment through an inflated inflatable structure.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic representation of an embodiment of the biofouling removal mechanism;

FIG. 2 is a side view of another embodiment of the biofouling removal mechanism having a cleaning element support structure with a helical structure;

FIG. 3 is an end view of the embodiment of the biofouling removal mechanism of FIG. 2;

FIG. 4 is a perspective view of an expandable embodiment of the biofouling removal mechanism in an expanded state and mounted on a structure to be cleaned;

FIG. 5 is a perspective view of the expandable embodiment of the biofouling removal mechanism of FIG. 4 passing over a first type of radial projection;

FIG. 6 is a perspective view of the expandable embodiment of the biofouling removal mechanism of FIG. 4 passing over a second type of radial projection;

FIG. 7 is a perspective view of another expandable embodiment of the biofouling removal mechanism in a deflated state and mounted on a structure to be cleaned;

FIG. 8 is a perspective view of the expandable embodiment of the biofouling removal mechanism of FIG. 7 in an inflated state;

FIG. 9 is a perspective view of an embodiment of cleaning elements for use in the biofouling removal mechanism where the cleaning elements contain rollers and are mounted on a structure to be cleaned;

FIG. 10 is a perspective view of an embodiment of cleaning elements and protective elements mounted on a structure to be cleaned;

FIG. 11 is a perspective view of an embodiment of the biofouling removal mechanism having a conical cleaning element support structure and a plurality of circular cleaning elements;

FIG. 12 is a perspective view of an embodiment of a single portion of the conical cleaning element support structure;

FIG. 13 is a cutaway view of the embodiment of the biofouling removal mechanism of FIG. 11;

FIG. 14 is a perspective view of the embodiment of the biofouling removal mechanism of FIG. 11 passing over a structure to be cleaned adjacent an enlarged portion of the structure to be cleaned;

FIG. 15 is a perspective view of a manual embodiment of the biofouling removal mechanism in an open position;

FIG. 16 is a perspective view of the manual embodiment of the biofouling removal mechanism in a closed position;

FIG. 17 is a partial view of the biofouling removal mechanism of

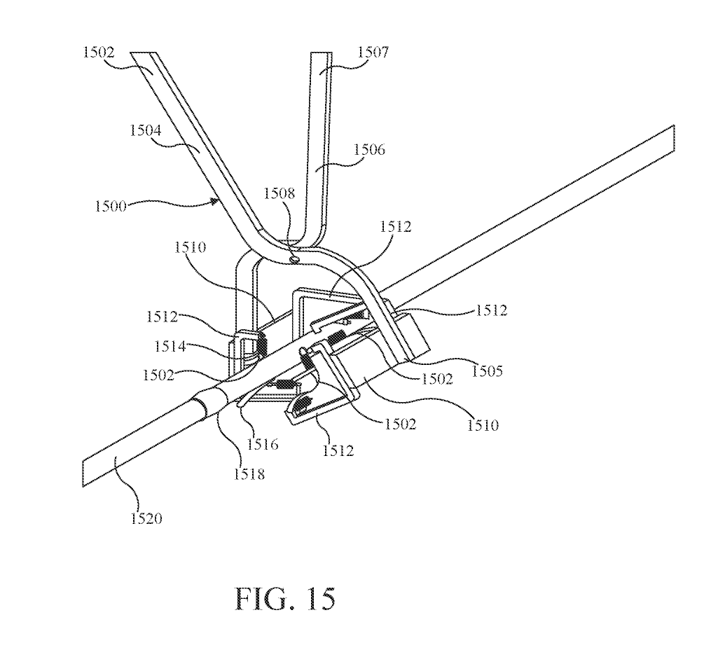

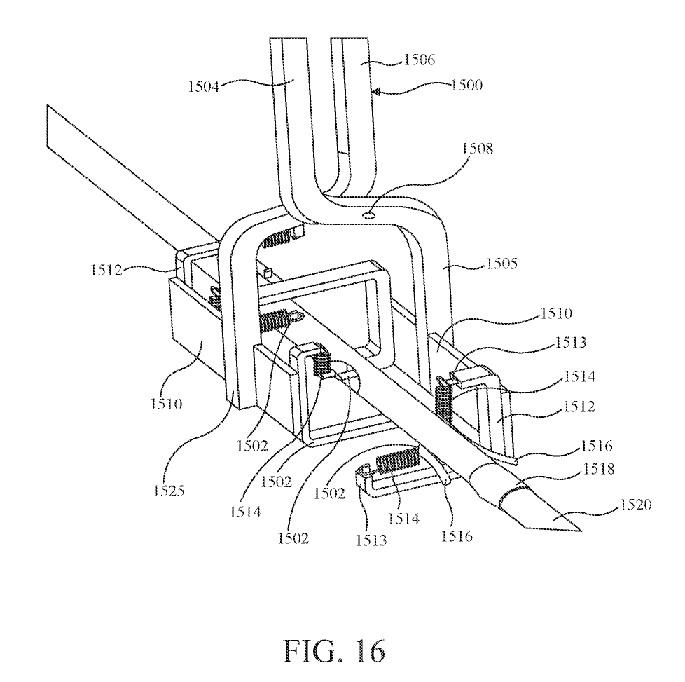

FIGS. 15 and 16 illustrating the cleaning elements;

FIG. 18 is a perspective view of another manual embodiment of the biofouling removal mechanism in an open position and having motor driven cleaning elements;

FIG. 19 is a perspective view of an embodiment of a motor driven cleaning element;

FIG. 20 is a perspective view of another embodiment of a motor driven cleaning element;

FIG. 21 is a perspective view of a yet another embodiment of a motor driven cleaning element;

FIG. 22 is a perspective exterior view from the top of an embodiment of the biofouling removal mechanism containing motor driven brushes and a protective housing;

FIG. 23 is a hidden line view of the embodiment of the biofouling removal mechanism of FIG. 22 illustrating interior elements; and

FIG. 24 is a flowchart illustrating an embodiment of a method for removing biofouling using the biofouling removal mechanism.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to local activity taking place within the area of a seismic survey. However, the embodiments to be discussed next are not limited to this configuration, but may be extended to other arrangements that include regional activity, conventional seismic surveys, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

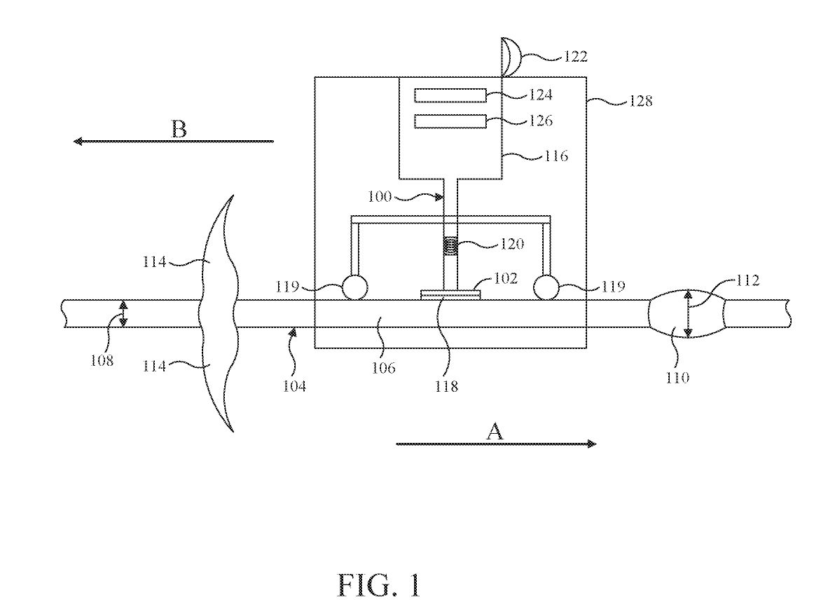

Referring initially to FIG. 1, exemplary embodiments are directed to a biofouling removal mechanism 100. The biofouling removal mechanism includes at least one cleaning element 102 configured to remove accumulated biofouling from the surface of a structure 104. As used herein, biofouling refers to plants and other organisms that attach to or grow on surfaces of structures that are maintained in an aquatic or marine environment for extended periods of time. This includes soft biofouling such as algae or cyprid stage barnacles/juvenile barnacles and hard biofouling such as adult stage barnacles. Suitable materials for the biofouling removal mechanism and all of its components include, but are not limited to, metals including steel, galvanized steel, aluminum, titanium and stainless steel, plastics, polymers, natural fibers, synthetic fibers, carbon fiber and combinations thereof.

The structures to be cleaned include any type of rigid or semi-rigid structure deployed in a marine environment. Suitable structures include, but are not limited to, the hulls of vessels, pipes, poles, pilings, ropes, wires, cables, fishing lines, sensors, buoys and ocean outfalls. These structures can be generally uniform in size and shape or can have sizes and shapes that vary along their length. In one embodiment, the structure to be cleaned is a towed sensor array or a streamer used in marine seismic surveys. The streamer includes one or more cylindrical cables 106 pulled behind a vessel. Each cable has a given diameter 108 and additional structures that are located along the length of the cable. These additional structures change the geometry of the structure to be cleaned, for example the size, i.e., diameter, or shape of the cable or streamer. Additional structures that change the diameter of the cable include a plurality of enlarged portions 110 that are arranged generally concentric with the cylindrical cable and that have an enlarged diameter 112 greater than the given diameter of the cable. These enlarged portions include, for example, weights, floats and joint overmoldings.

The additional structures also include a plurality of radial projections 114 that extend radially out from the cylindrical cable. These radial projections are associated with birds or wings used to control, guide or steer the streamer cable. Examples of these radial projections include the Nautilus® streamer positioning mechanism, which is commercially available from Sercel Incorporated of Houston, Tex., and streamer retriever devices available from OYO Geospace Corporation. In general, these types of radially projecting structures are referred to as winged or bird type structures. Embodiments of the biofouling removal mechanism accommodate the changes in geometry that include concentric enlargements and radial projections when removing accumulated biofouling.

In addition to a single cleaning element, the biofouling removal mechanism can include a plurality of separate and distinct cleaning elements, each configured to remove accumulated biofouling from the surface of a structure. In one embodiment, each cleaning element is configured to remove the same type of biofouling. Alternatively, the cleaning elements are configured to remove different types of biofouling, e.g., soft biofouling or hard biofouling. In one embodiment, the cleaning element is configured to remove both soft biofouling and hard biofouling accumulations.

Suitable cleaning elements include, but are not limited to, an edge tool such as a knife or blade. The edge tool can have a straight edge, a curved edge, a serrated edge or a saw tooth edge. Other suitable edge tools include wires. In one embodiment, the cleaning element is arranged as a brush, for example a metal wire brush or a plastic wire brush. In one embodiment, the cleaning element is flat. Alternatively, the cleaning element is curved or contoured to complement the shape of the surface of the structure from which the biofouling is being removed. The cleaning element can be rigid or malleable, conforming to the shape of the surface of the structure to be cleaned.

In one embodiment, each cleaning element extends partially or completely around the structure. Therefore, the plurality of cleaning elements, in combination, covers an entire surface of the structure to be cleaned. For a cylindrical or elongated structure, the cleaning elements include a plurality of circular cleaning scrapers. Each circular cleaning scraper surrounds the structure to be cleaned, and all of the circular cleaning scrapers are arranged co-axially. Each one of the circular cleaning scrapers has a unique diameter, which facilitates structures of different or varying diameters. Arranging these cleaning elements co-axially and spaced along the axis defines a generally conical structure. In this embodiment, the cleaning element support structure includes a hollow conical housing constructed from a plurality of separate sections. The circular cleaning elements are attached to an interior of the hollow conical housing. At least one elastic band passes completely around the hollow conical housing on an exterior of the hollow conical housing opposite the interior. This holds the separate sections together and allows for expansion of the hollow conical housing.

Additional accommodations for changes in the size and shape of the structure to be cleaned are accomplished by a leading edge or curved guide extending from the cleaning element that curves away from the structure to be cleaned and guides the cleaning element over these changes in the size and shape of the structure.

The biofouling removal mechanism 100 also includes a cleaning element support structure 116 attached to the cleaning element. The cleaning element support structure is configured to secure the cleaning element to the structure to be cleaned, to guide the cleaning element along the surface of the structure to be cleaned and to accommodate changes in at least one of a size and a shape of the structure to be cleaned as the cleaning element passes along this structure. The cleaning element support structure contains all of the structural elements to support the cleaning element, to attach the cleaning element to the structure in situ, to hold the cleaning element in a desired position against the structure, to remove the cleaning element from the structure, to facilitate movement of the cleaning element relative to the structure, for example in the direction of arrow A, to propel the cleaning element in the direction of arrow A and to accommodate radially expanded 110 portions of the structure and radial extensions 114 of the structure that are encountered while the cleaning element is moving in the direction of arrow A.

In one embodiment, at least one of the cleaning elements and the cleaning element support structure includes protective elements 118 disposed between the cleaning element and the surface of the structure to be cleaned to prevent contact between the cleaning element and the surface structure to be cleaned. This prevents damage to or marking of the surface of the structure. The protective element also establishes a pre-defined spacing between the cleaning element and the structure. The protective element can be a plurality of parallel cords or cables spaced from each other and extending along the structure to be cleaned in a direction in which the cleaning element passes over the structure, i.e., the direction of arrow A. Other protective elements include plates or tangs that extend from the cleaning element support structure and contact the surface of the structure being cleaned to establish the desired distance of separation. In one embodiment, the cleaning element support structure includes a biasing 120 member to bias the cleaning element toward the surface of the structure to be cleaned. Suitable biasing members include springs, either coil type springs or leaf type springs.

In one embodiment, the cleaning element support structure is arranged as a helical structure with the cleaning element disposed in an interior of the helical structure. The structure to be cleaned, including any enlargements and winged members, passes through the interior of the helical structure. At least one strut is in contact with the helical structure and the cleaning element to position the cleaning element in the interior of the helical structure at a desired location to contact the surface of the structure to be cleaned. In one embodiment, this strut is constructed from a flat piece of metal and also functions as the biasing member. The strut bends or flexes to allow the cleaning elements to accommodate changes in the shape and size of the structure to be cleaned.

In one embodiment, the cleaning element support structure is an expandable structure, e.g., a foldable structure or an inflatable structure. This foldable structure has a folded position used, for example, when attaching to the biofouling removal mechanism to the structure to be cleaned, and an expanded position, used during cleaning to accommodate changes in the size and shape of the structure to be cleaned. The foldable structure facilitates deployment from a small workboat having limited space. As the foldable structure requires less space on the workboat, more space is available on the workboat for additional tools. The inflatable structure has a deflated position used, for example, when attaching to the biofouling removal mechanism to the structure to be cleaned, and an inflated position, used during cleaning to accommodate changes in the size and shape of the structure to be cleaned.

In one embodiment, at least one of the cleaning elements and the cleaning element support structure includes a plurality of rollers or wheels 119 that contact the surface of the structure to be cleaned. These rollers facilitate passage of the biofouling removal mechanism over and along the surface of the structure to be cleaned.

In general, the structure to be cleaned moves relative to the biofouling removal mechanism in a direction as shown by arrow B, which is opposite to the direction of movement of the biofouling removal mechanism. This relative motion results from the motion of the structure during normal operation, e.g., movement of a ship or towing of a seismic streamer, or during deployment or retraction of the seismic streamer. As the biofouling removal mechanism is not fixed to a single position along the length of the structure, propulsion can be accomplished using the drag on the cleaning element support structure by water. In general, relative motion between the structure to be cleaned and the biofouling removal mechanism is needed. Therefore, addition driving mechanisms can also be deployed. For example, a cable can be retracted by a motor, and the biofouling removal mechanism can be mounted in a fixed position, for example on a vessel. The cable is then moved relative to the biofouling removal mechanism.

In one embodiment, the cleaning element support structure includes a propulsion mechanism to drive the biofouling removal mechanism along the structure. Suitable propulsion mechanisms include passive mechanisms such as a drag canopy 122 or other sail-type mechanism. Alternatively, the propulsion mechanism is an active mechanism that comprises a propulsion motor. This motor can be in contact with the wheels to propel the biofouling removal mechanism along the surface of the structure to be cleaned. In addition, the motor is in communication with the cleaning element to move the cleaning element, e.g., a wire-type brush, relative to the cleaning element support structure. This can improve the removal of biofouling and also provide propulsion. Additional elements within the cleaning element support structure include at least one of ballast 126 and a buoy 124. In one embodiment, the cleaning element support structure includes and is surrounded by a protective housing 128.

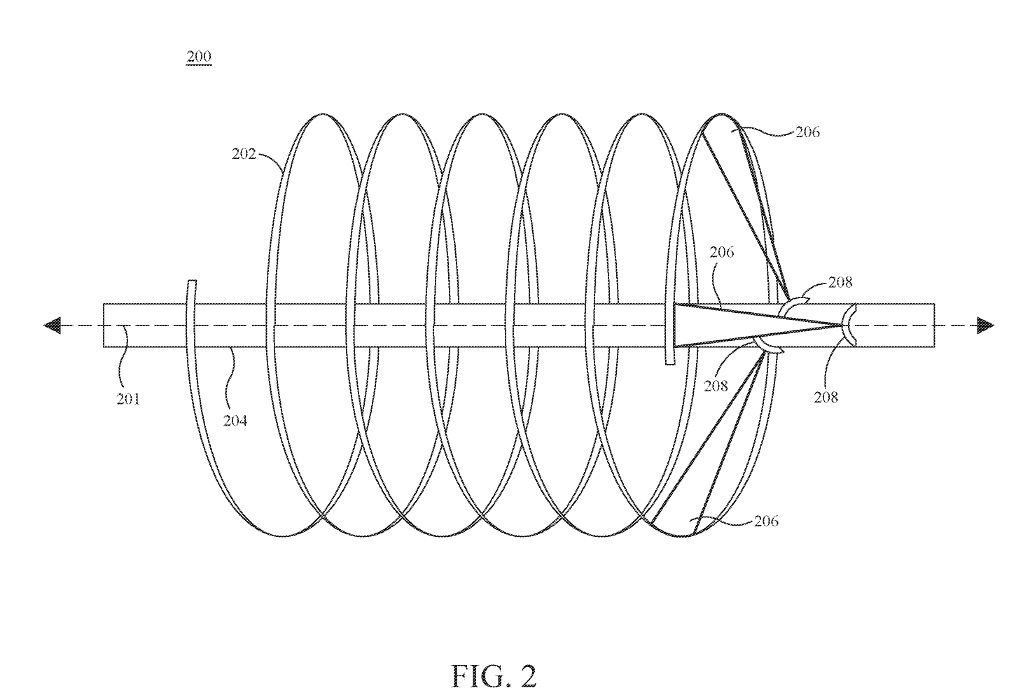

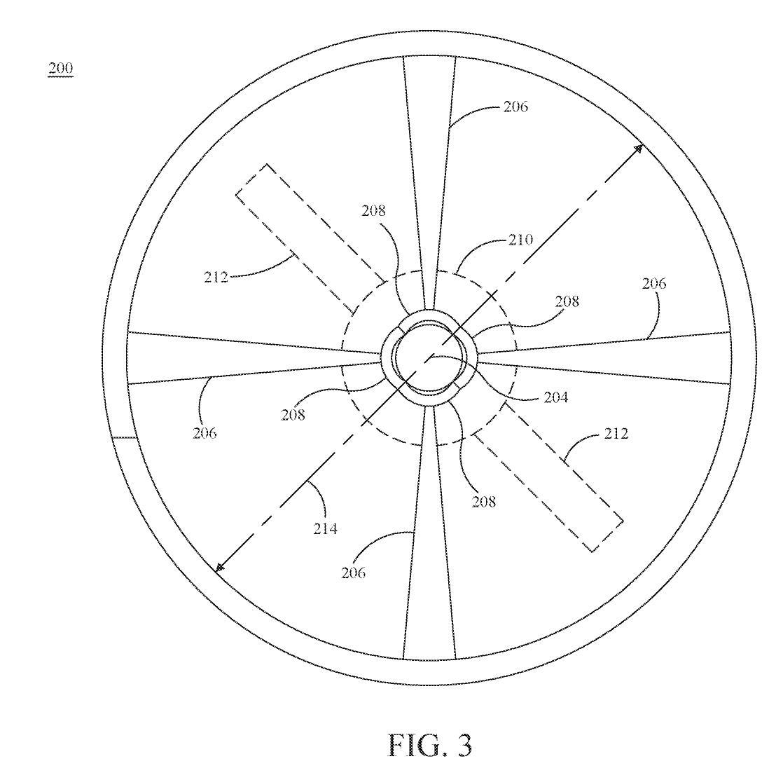

Referring to FIGS. 2 and 3, an exemplary embodiment of a biofouling removal mechanism 200 is illustrated in which the cleaning element support structure 202 is arranged as a helical structure. Suitable helical structures include, but are not limited to, a helix constructed from wires or tubes and a helicoid or helicoidal structure that is constructed from a sheet of material such as metal or plastic that has a desired thickness or surface area and that is formed into the helicoid. The helical structure can have a constant diameter along its length or a diameter that varies along its length, yielding a conical shape as opposed to a cylindrical shape. The direction of the wind of the helical structure can be either left-handed or right-handed and the tightness of the wind, pitch can be varied. Suitable cross-sectional shapes for the helical structure include, but are not limited to, circular, oblong or elliptical, rectangular and polygonal. The surfaces of the helicoidal structure can be smooth or can have a texture to improve biofouling removal.

The structure 204 to be cleaned, e.g., the streamer, passes through the interior or center of the helical structure or between adjacent windings of the helical structure as the biofouling removal mechanism rotates with respect to the structure to be cleaned. The helical structure provides sufficient structural support and absorption of forces applied to the biofouling removal mechanism along the axis 201 of the helical structure. Also disposed in the interior of the helical structure is the plurality of cleaning elements 208. Each one of the plurality of cleaning elements is spaced from the other cleaning elements along a length of the structure to be cleaned. In addition, each cleaning element extends at least partially around the structure to be cleaned. Therefore, in combination, the plurality of cleaning elements covers the entire surface of the structure to be cleaned.

A plurality of struts or blades 206 extend from different positions on the helical structure to each one of the plurality of cleaning elements. In one embodiment, one strut is provided for each cleaning element. Alternatively, additional struts are provided along the helical structure and multiple struts are in contact with each one of the cleaning elements for additional stability. Each strut is attached to a different location along the helical structure. In one embodiment, the struts are constructed of a flexible material, e.g. spring steel or plastic, to hold the cleaning elements to the surface of the structure 204, to accommodate changes in the diameter of the structure and to accommodate passage of the structure through the interior of the helical structure in non-centric orientations. The length of the struts and the interior diameter of the helical structure are sufficient to permit passage of enlarged portions 210 and radial projections 212. The struts are also spaced and aligned to facilitate passage of the radial projections between adjacent struts and adjacent windings of the helical structure.

The biofouling removal mechanism moves along the structure, for example, under the force of drag. Drag canopies and floats can be added to enhance the effects of drag. In one embodiment, the biofouling removal mechanism rotates as it moves along the length of structure to be cleaned. Rotation can be caused by contact with obstacles. In one embodiment, the blades are angled to induce the desired direction of rotation in the biofouling removal mechanism. Rotation allows the biofouling removal mechanism to pass all obstacles and changes in geometry along the length of the structure to be cleaned. For a seismic streamer, these obstacles include the spreader ropes between the cables, ropes and chains used to attach floats and obstacles like nautilus bodies. In one embodiment, the distance between the coils or windings of the helical structure is bigger than the thickness of the obstacle. The passage over these obstacles is possible even if the diameter of the helical structure is less than the diameter than the obstacle. As the biofouling removal mechanism can accommodate any obstacle, deployment from the back deck of the towing vessel is possible.

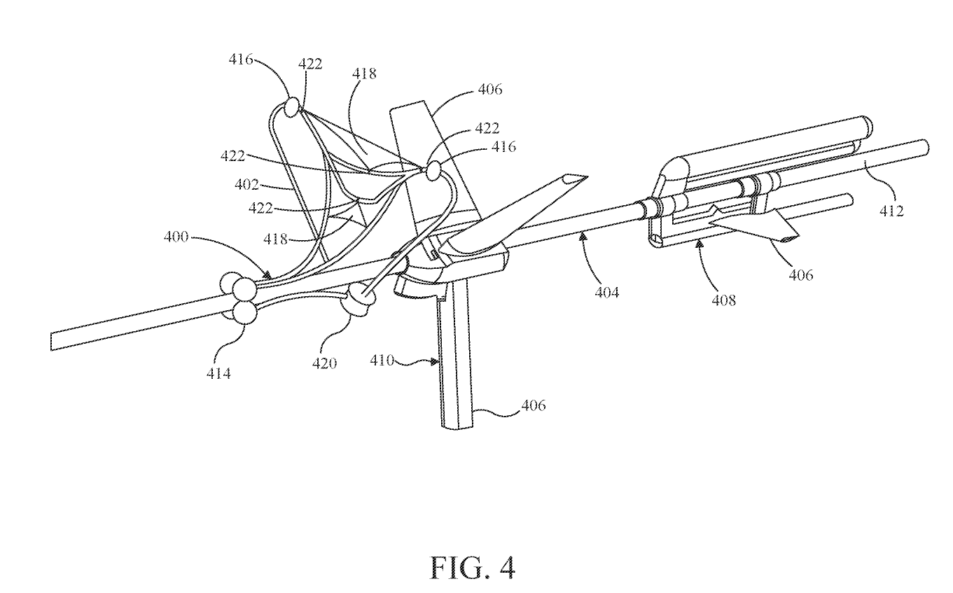

Referring to FIGS. 4-6, an exemplary embodiment of a biofouling removal mechanism 400 is illustrated in which the cleaning element support structure 402 is arranged as an expandable or foldable structure that accommodates enlarged portions of the structure 404 to be cleaned. These enlarged portions include radial projections 406 located along the length of the cable 412. These radial projections include the wings of both Nautilus-type birds 410 and Ion-type birds 448. The cleaning element support structure is attached to one of more cleaning elements 414. The cleaning element support structure 402 of this embodiment can be used in combination with any type of cleaning element disclosed herein.

The cleaning element support structure is constructed from a plurality of separate and independent structural elements such as tubing, pipes or rods, including both solid rods and hollow tubing. These structural elements are connected together using a combination of rigid connections and flexible, foldable or articulating connections 422. These articulating connections provide for relative movement among the structural elements and, therefore, moving of the cleaning element support structure between a first, folded position that can be used for storage and attachment and a second, unfolded or expanded position (as illustrated) that is used when the biofouling removal mechanism is passing along the structure. In one embodiment, the cleaning element support structure is manually placed in the expanded position and can be locked in this position. In this embodiment, moving the cleaning element support structure to the expanded position deploys one or more drag canopies 418 that are attached to various locations along the structural elements.

In another embodiment, the cleaning element support structure is moved to the expanded position through the motion of the cleaning element support structure along the structure to be cleaned. Expansion of the cleaning element support structure is enhanced or facilitated using drag canopies 418 either alone or with additional elements such as pre-loaded springs, floating elements and weights that apply force to various positions on the structural supports, causing those supports to move relative to each other into the expanded position. The cleaning element support structure can also include one or more floats or buoys 416. These buoys can be made of any type of buoyant material, and are placed at locations on the cleaning element support structure to achieve the desired vertical orientation of the cleaning element support structure with respect to the structure to be cleaned, it also enables the expansion of the tool in its cleaning configuration. In one embodiment, the cleaning element support structure includes one or move wheels 420 that engage the surface of the structure to be cleaned, e.g., the cable. These wheels are rotatable with respect to the structural elements to which they are attached and facilitate movement of the cleaning element support structure along the structure to be cleaned. The wheels can also provide for secure attachment of the cleaning element support structure to the structure to be cleaned. In one embodiment, the wheels include sufficient weight to function as ballast. In this embodiment, the wheels work in conjunction with the buoys to achieve the desired vertical orientation of the cleaning element support structure.

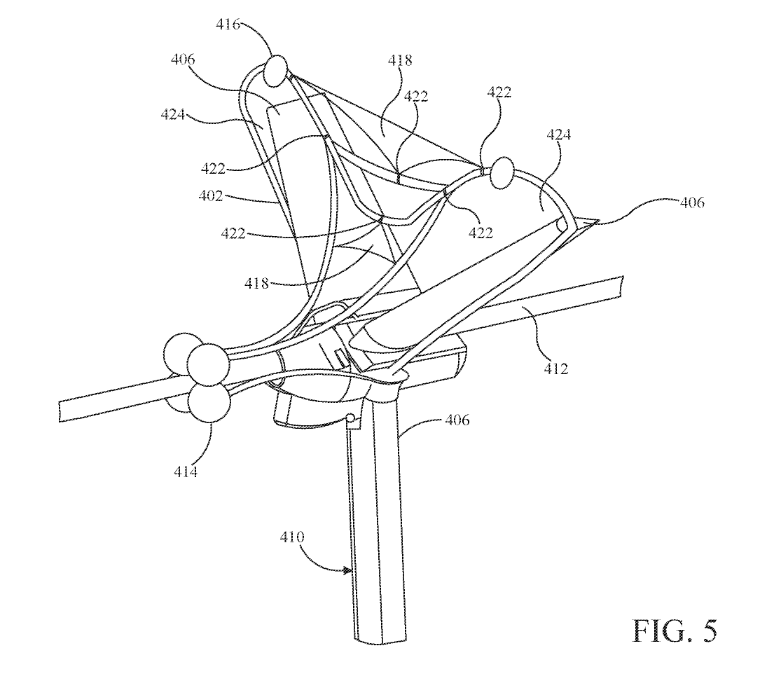

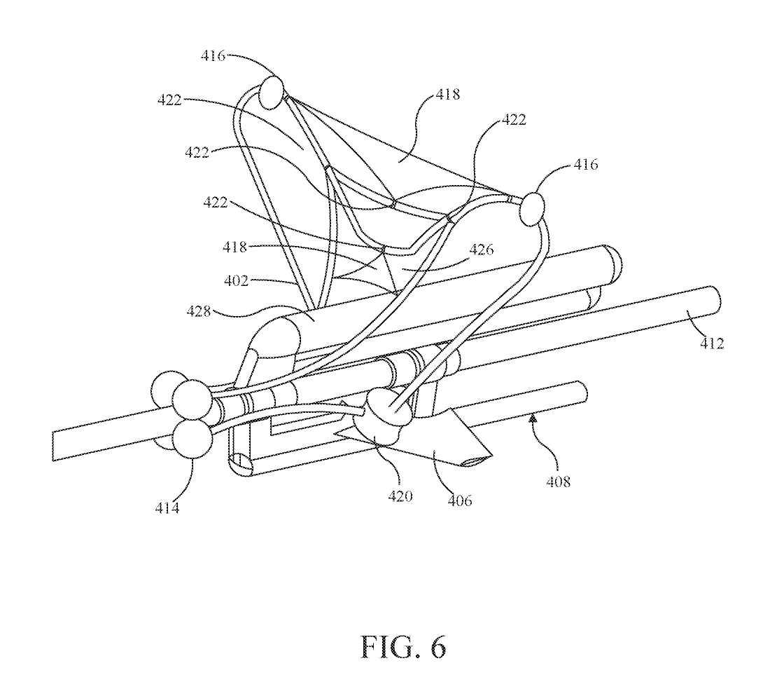

In the expanded position, the structural supports define voids or spaces 424 in the cleaning element support structure that are of sufficient size to accommodate any radial projections 406 in the path of the biofouling removal mechanism (FIG. 5). In addition, the cleaning element support structure can pass over other types of radial projections 406 in its path (FIG. 6) and include alternative voids or spaces 428 to accommodate the passage of radial projection structures associated with these other types of radial projections. Therefore, a single cleaning element support structure can accommodate multiple types of winged structures. The buoys, wheels and ballast are positioned to provide the required orientation between spaces in the cleaning element support structure and all types of winged structures located along the length of the structure to be cleaned.

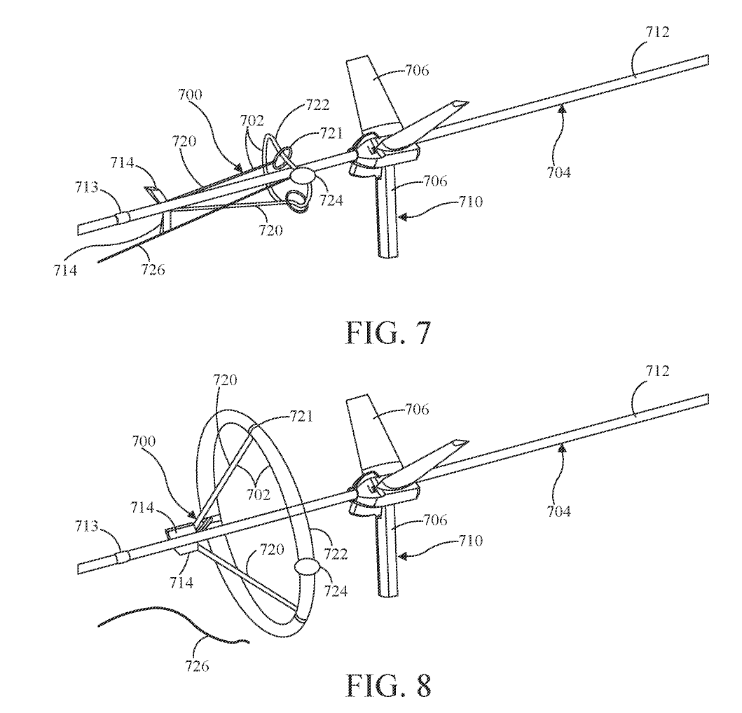

Referring to FIGS. 7 and 8, an exemplary embodiment of a biofouling removal mechanism 700 is illustrated in which the cleaning element support structure 702 is arranged as an expandable or inflatable structure that accommodates enlarged portions of the structure 704 to be cleaned. These enlarged portions include radial projections 706 located along the length of the cable 712 of the structure to be cleaned, which also includes enlarged areas 713, such as joints or weights. These radial projections are illustrated as the wings of a Nautilus-type bird 710, although this embodiment can also work with Ion-type birds (not shown). The cleaning element support structure is attached to one of more cleaning elements 714. The cleaning element support structure 702 of this embodiment can be used in combination with any type of cleaning element disclosed herein.

The cleaning element support structure includes at least one inflatable structure 722. A plurality of connecting arms 720 run from the inflatable structure to each one of the cleaning elements. Suitable connecting arms include tubing, pipes or rods, including both solid rods and hollow tubing. In one embodiment, the connecting arms include a circle or ring 721 on a first end, and the inflatable structure passes through this ring. The second end of each connecting arm opposite the first end is attached to one of the cleaning elements using either fixed connection or an articulating connection. Articulating connections provide for relative movement between the connecting arms and the cleaning element, allowing the cleaning elements to remain in contact with the structure to be cleaned.

The inflatable structure 722 has a first deflated state (FIG. 7) and a second inflated state (FIG. 8). When the connecting arms are fixedly secured to the cleaning elements, the cleaning elements are not in contact with the surface of the structure to be cleaned. When the inflatable structure is in the first state and is in contact with the surface of the structure to be cleaned, the inflatable structure is in the inflated state. In one embodiment, the cleaning element support structure includes at least one inflating mechanism 724 in communication with the inflatable structure. Suitable inflating mechanisms that are suitable for supplying air or other gases in a marine or aquatic environment are known and available in the art. The inflating mechanism can be manually or automatically actuated. In one embodiment, a tether 726 is provided with one end attached to the inflating mechanism. They second end is held by an operator or attached to a vessel or other work boat. Pulling on the second end of the tether, initiates the inflating mechanism, inflates the inflatable structure and releases the tether from the inflating mechanism.

In one embodiment, the inflatable structure is arranged as a circular ring. However, other shapes can be used. The circular ring has a diameter sufficient to accommodate any radial projections along the path of the biofouling cleaning mechanism. The connecting arms are oriented to not contact the radial projections. This alignment can be enhanced by providing ballast in the inflatable structure. The inflatable structure provides the desired buoyancy, and the drag created by the inflatable structure provides propulsion to the biofouling removal mechanism. If desired, additional propulsion mechanisms can also be provided.

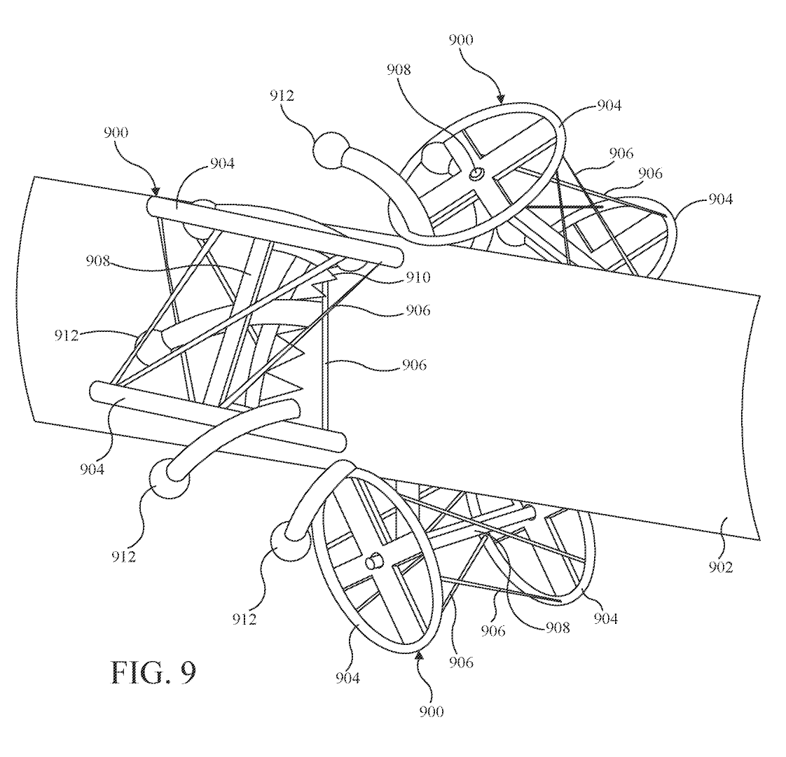

Referring to FIG. 9, an embodiment of cutting elements 900 for use with embodiments of the biofouling removal mechanism described herein is illustrated. A plurality of cutting elements is illustrated disposed around a structure to be cleaned 902, e.g., a cable or streamer. Each cutting element is associated with a pair of wheels 904 connected to and rotatable about a central axis 908. Each wheel is in contact with the surface of the structure to be cleaned. Rotation about the axis moves the wheels, and therefore the cutting element, along the surface of the structure 902. Attached to and extending down from each axis is a blade 910 held in fixed position at the surface of the structure. As illustrated, each blade is an edge tool having a saw tooth pattern to engage biofouling 912 and cut that biofouling from the surface of the structure. The blade can be curved to match the curvature of the surface of the structure. Movement of the wheels along the surface of the structure to be cleaned moves the blade, engaging and removing any biofouling in its path. Each cutting element can also include additional internal support structures such as cabling arranged to provide the desired support and rigidity to the overall structure of the cutting element. While illustrated as part of the cleaning element, the wheels and associated structure can be part of the cleaning element support structure, and the cleaning elements are limited to the blades or other edge tools. In general, an objective is to avoid any damage of the streamer with the elements 906. The cutting elements are not in direct contact with the streamer or surface to be cleaned,

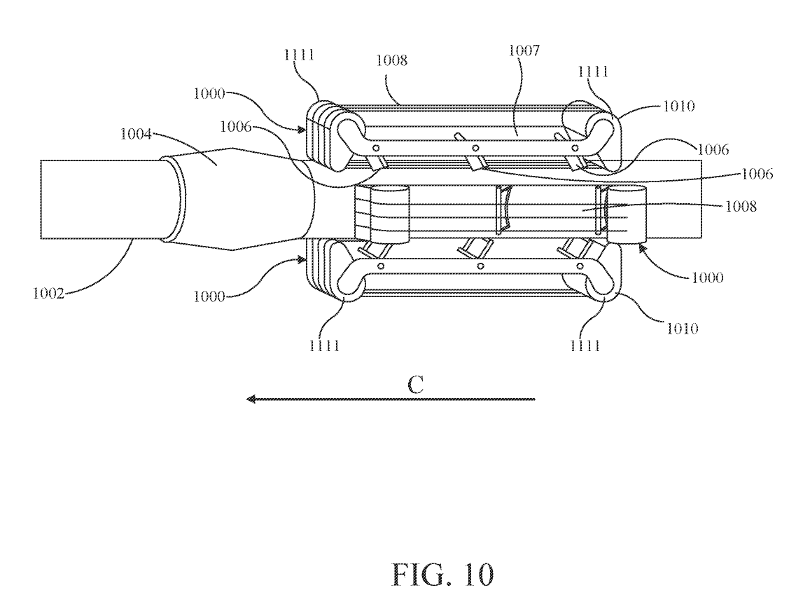

Referring to FIG. 10, another embodiment of cutting elements 1000 for use with embodiments of the biofouling removal mechanism described herein is illustrated. A plurality of cutting elements are illustrated disposed around a structure to be cleaned 1002, e.g., a cable or streamer, that includes an enlarged area 1004 such as a joint or a weight. Each cutting element includes a plurality of edge tools 1006 such as blades or knives attached to a rigid frame 1007. At least one of the cleaning element and the cleaning element support structure includes a protective element 1008 disposed between the edge tools and the surface of the structure to be cleaned. This protects the surface from direct contact with the edge tools and establishes the desired spacing between the edge tools and the surface of the structure to be cleaned. As illustrated, the protective element is a plurality of parallel lines, wires or cables, spaced from each other and running along the surface of the structure to be cleaned in the direction of movement of the cleaning element along the surface as indicated by arrow C. Using wires minimizes the area of the surface covered by the cleaning elements and allows the biofouling to extend through the protective element and into contact with the edge tools. The wires pass through guides or spindles 1111 attached to the rigid frame 1007. Therefore, the wires rotate through the spindles as the cleaning element moves along the surface. Rotation through the spindles prevents the wires from dragging across the surface of the structure to be cleaned. The wires function as tracks, moving the cleaning elements along the surface. This also provides for transitioning or riding over the enlarged areas 1004 of the structure to be cleaned. In one embodiment, a motor is provided in communication with one of the spindles. Rotation of the spindle by the motor facilitates the use of the protection element as a propulsion mechanism.

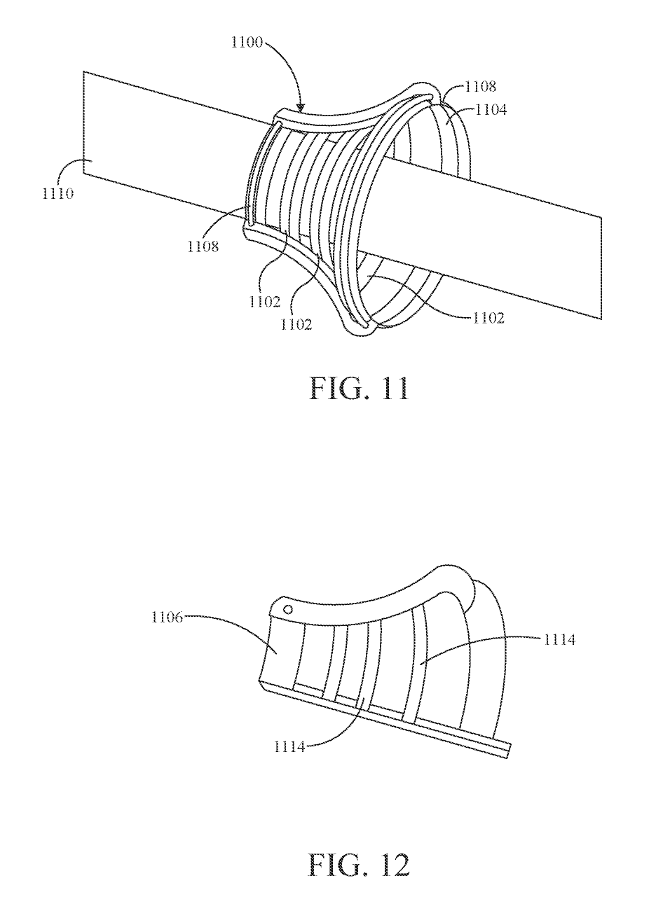

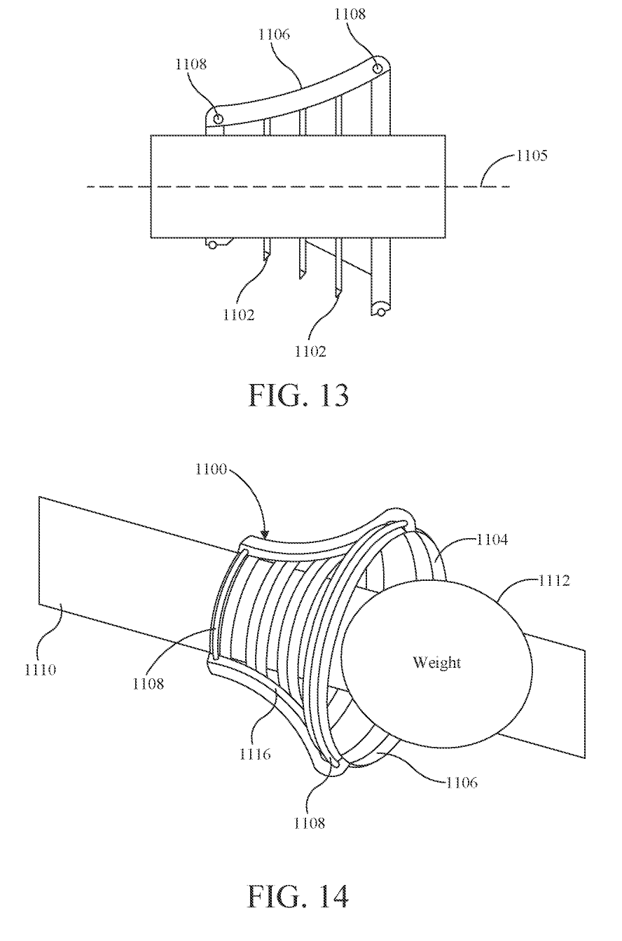

Referring to FIGS. 11-14, in one exemplary embodiment of the biofouling removal mechanism 1100, the plurality of cleaning elements 1102 are a plurality of circular cleaning scrapers disposed in the cleaning element support structure that is arranged as a hollow conical housing 1104. Each circular cleaning scraper surrounds the structure to be cleaned and all of the circular cleaning scrapers are arranged co-axially, i.e., spaced along a common axis 1105. Each one of the circular cleaning scrapers has a unique diameter, which facilitates structures 1110 of different or varying diameters or the enlarged areas 1112 along the length of the structure to be cleaned. Arranging these cleaning elements co-axially according to diameter and spaced along the axis defines a generally conical structure. The circular cleaning scrapers are attached to the cleaning element support structure. This maintains the desired spacing and alignment among the circular cleaning scrapers.

In one embodiment, the cleaning element support structure contains a plurality of separate and distinct sections 1106. Each section represents a portion of the overall hollow conical housing. At least one expandable or elastic band 1108 passes completely around the hollow conical housing on an exterior of the hollow conical housing opposite the interior. Suitable elastic bands include bands constructed from an elastomer. The elastic band holds the separate sections together and allows for expansion of the hollow conical housing as the separate sections can expand outwards away from each other. The circular cleaning scrapers are also constructed to allow for expansion. For example, each circular cleaning scraper can include elastic sections or can be arranged as a retaining ring or expandable ring. Alternatively, each circular cleaning scraper includes a plurality of circular cleaning scraper sections 1114, with each section attached to one of the support structure sections 1106. Therefore, as the support structure sections expand, the circular cleaning scrapers expand.

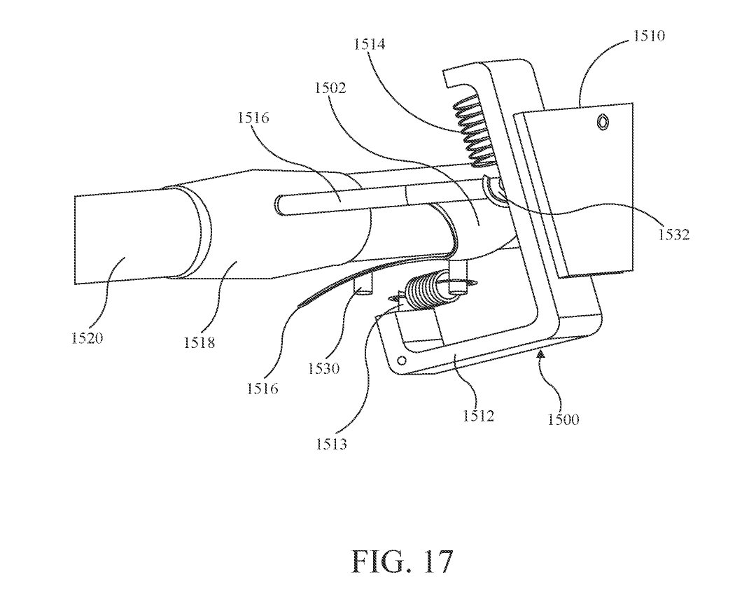

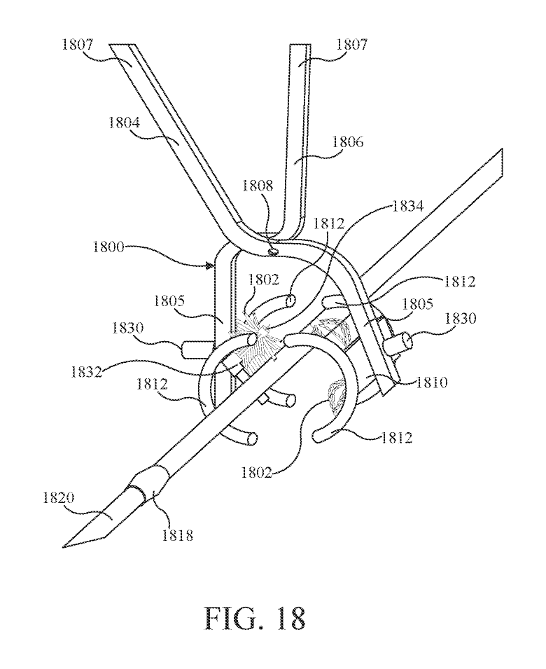

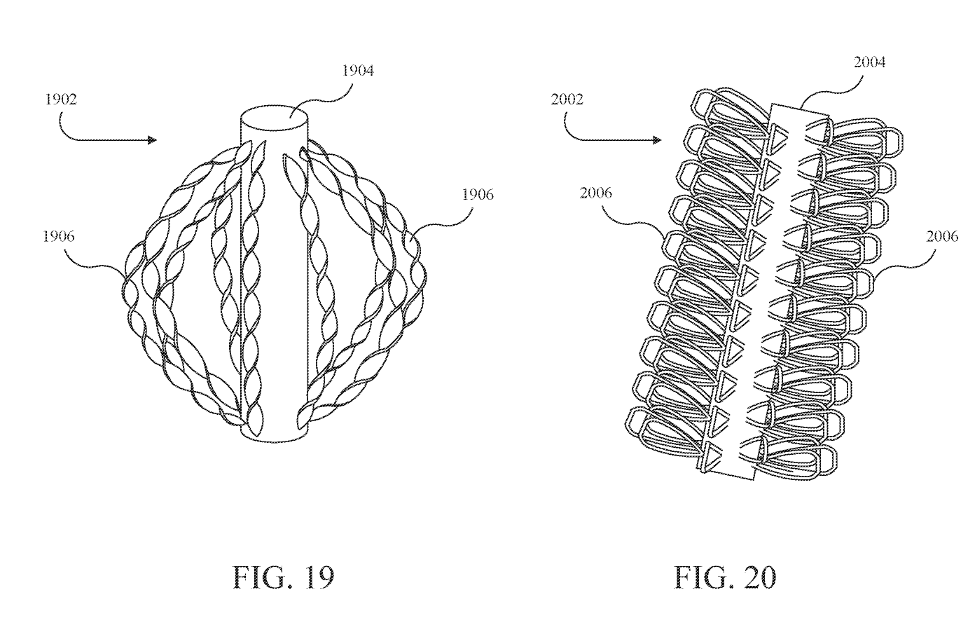

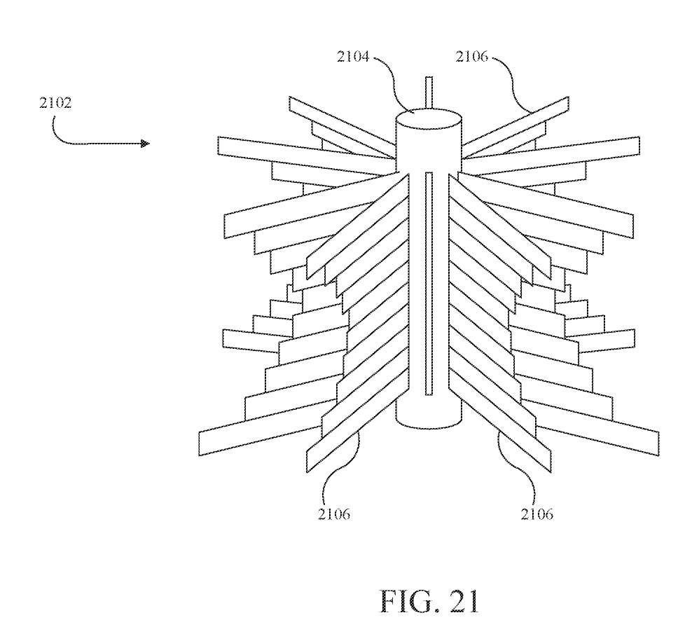

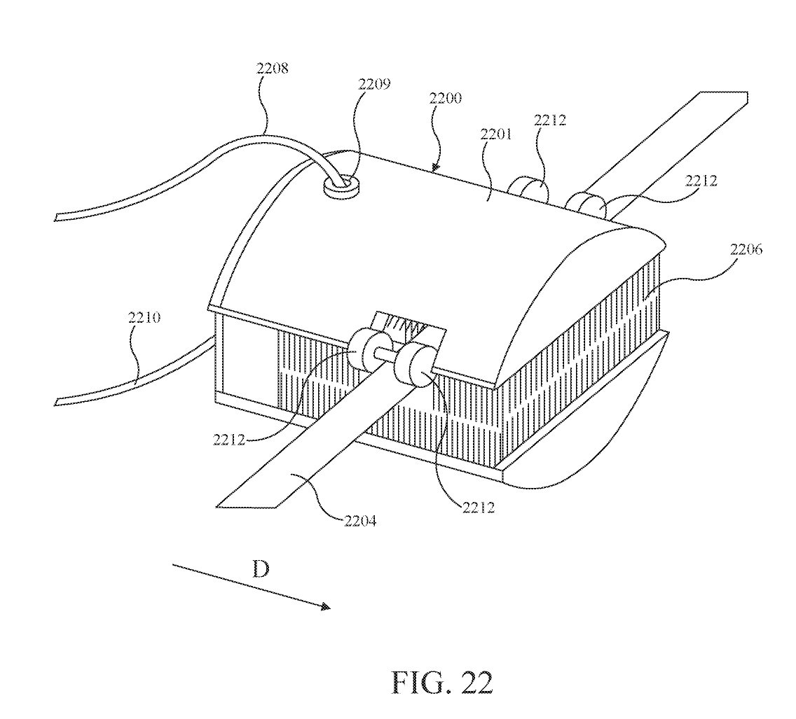

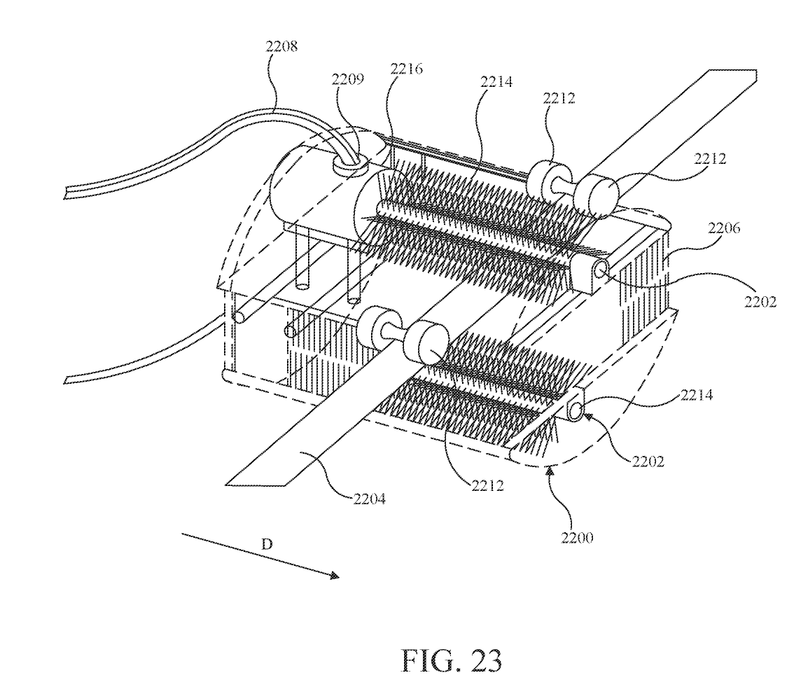

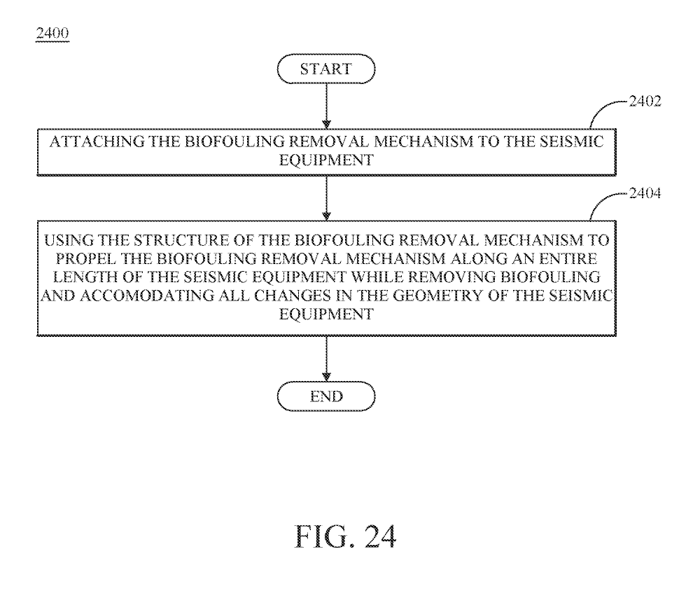

Referring to FIGS. 15-17, in one exemplary embodiment of the biofouling removal mechanism 1500, the plurality of cleaning elements 1502 are a plurality of edge tools disposed in a cleaning element support structure that is arranged as a manually engaging pair of pivoting members selectively positionable in an open position (FIG. 15) for engaging the structure to be cleaned and a closed position (FIG. 16) for secure attachment to the structure. Locking mechanisms can be used to hold the pivoting members in the closed position.

The cleaning element support structure includes a first arm 1504 connected to a second arm 1506 at a pivot point 1508. Moving the first arm relative to the second arm about the pivot point moves the cleaning element support structure between the open position and the closed position. Attached to each arm on an engagement end 1505 of that arm is a cross member 1510. The end of each arm opposite the engagement end is the handle end 1507. The handle end is held by an operator when attaching the biofouling cleaning mechanism to the structure to be cleaned. The handle end can be held or pulled by the operator along the length of the structure to be cleaned. Alternatively, the handle ends are mounted to a stationary support, and the structure to be cleaned is moved relative to the biofouling removal mechanism.

Attached to each cross member is a plurality of cleaning element holders 1512. As illustrated, each cross member includes two cleaning element holders; however, each cross member can include only one cleaning element holder or more than two cleaning element holders. Each cleaning element holder is associated with one cleaning element and is arranged to hold that cleaning element against the surface of the structure to be cleaned 1520 while allowing for movement of that cleaning element over enlarged portions 1518 of the structure to be cleaned such as weights or joints. In one embodiment, each cleaning holder element is configured to position a given cleaning element at a separate or unique position on the surface of the structure to be cleaned. For example, the cleaning elements associated with the cross member attached to the first arm contact the top and bottom of the structure to be cleaned, and the cleaning elements associated with the cross member attached to the second arms contact opposite sides of the structure to be cleaned.

In one embodiment, each cleaning element holder is an angled or “L” shaped support having a tang 1513 disposed on either end. In general, the cleaning elements are disposed in the interior area of these angled supports. Each cleaning element also includes two tangs 1532, and a biasing member 1514 extends between each cleaning element tang and the tang on one end of the cleaning element holder.

These biasing members bias the cleaning element into contact with the surface of the structure to be cleaned and also allow movement of the cleaning member relative to the cleaning element holder. Suitable biasing members include, but are not limited to, coil springs.

Each cleaning element includes at least one leading edge 1516 or guide configured to curve away from the surface of the structure to be cleaned to guide the cleaning element over changes in the size and shape of the structure. In one embodiment, each cleaning element includes a leading edge or guide at either end of the cleaning element. Each leading edge can also include a stop 1530 extending from the leading edge towards the cleaning element holder. This stop limits the range of motion of the leading edge towards the cleaning element holder to prevent the structure to be cleaned from contacting the cleaning element support structure and to maintain a desired positioning of the structure to be cleaned through the cleaning element support structure.

Referring to FIG. 18, in another exemplary embodiment of the biofouling removal mechanism 1800, the plurality of cleaning elements 1802 are a plurality of high speed rotating elements disposed in the cleaning element support structure that is arranged as a manually engaging pair of pivoting members selectively positionable in an open position for engaging the structure to be cleaned and a closed position for secure attachment to the structure to be cleaned. Locking mechanisms can be used to hold the pivoting members in the closed position.

The cleaning element support structure includes a first arm 1804 connected to a second arm 1806 at a pivot point 1808. Moving the first arm relative to the second arm about the pivot points moves the cleaning element support structure between the open position and the closed position. Attached to each arm on an engagement end 1805 of that arm is a cross member 1810. The end of each arm opposite the engagement end is the handle end 1807. The handle end is held by an operator when attaching the biofouling cleaning mechanism to the structure to be cleaned. The handle end can be held or pulled by the operator along the length of the structure to be cleaned. Alternatively, the handle ends are mounted to a stationary support, and the structure to be cleaned is moved relative to the biofouling removal mechanism.

Attached to each cross member is a plurality of guiding elements 1812. As illustrated, each cross member includes two guiding elements, one on either end of the cross member; however, each cross member can include only one guiding element or more than two guiding elements. The cleaning elements 1802 are disposed along the cross member between the guiding elements. In one embodiment, each guiding element has a “U” shape. The guiding elements on the first and second arms are arranged as opposite pairs, and when the arms are in the closed position, these opposed guiding elements contact each other and form a closed guide. The structure to be cleaned 1820 passes through the interior of the closed guide, which is large enough to allow for movement of that cleaning element over enlarged portions 1818 of the structure to be cleaned such as weights or joints. In one embodiment, each guiding element is configured from circular tubing or circular bar stock.

In one embodiment, the cleaning element support structure includes at least one motor 1830 mounted on a cross member. Preferably, the cleaning element support structure includes two motors, and each motor is mounted on one of the cross members. Each motor is in communication with a central shaft 1834 of one or more cleaning elements through a gear box 1832 or transmission. The gear box translates the rotational motion of the motor directly to each one of the attached cleaning elements. Alternatively, the cleaning elements are linked, and rotation of one cleaning element rotates the other cleaning elements. The cleaning elements are positioned adjacent the surface of the structure to be cleaned when the arms are in the closed position, and the motor rotates each cleaning element relative to the surface of the structure to be cleaned. In one embodiment, the motor rotates each cleaning element at least about 500 rpm. Suitable motors include electrical motors and hydraulic motors. The speed and direction of rotation can be controlled based on the type of biofouling to be removed.

Referring to FIGS. 19-21, different types of rotating cleaning elements can be used. A single type of rotating cleaning element can be used base on the type of biofouling to be removed. Alternatively, different types of rotating cleaning elements are used so that a single biofouling removal mechanism can be used for multiple types of biofouling. Referring to FIG. 19, one embodiment of the cleaning element 1902 includes a central shaft 1904 and a plurality of cord elements 1906 attached to the exterior of the central shaft. Each cord element is attached to the exterior of the central shaft at two positions. These positions are located near opposite ends of the central shaft, and the length of each cord element is greater than the length of the central shaft. Therefore, rotation of the cleaning element causes the cord elements to bow out from the central shaft and contact the surface of the structure to be cleaned. Suitable materials for the cord elements include synthetic, i.e., plastic, or natural fiber rope. The use of softer materials protects the surface of the structure to be cleaned from damage. In one embodiment, each cord is twisted for additional rigidity and improved biofouling removal.

Referring to FIG. 20, one embodiment of the cleaning element 2002 includes a central shaft 2004 and a plurality of cord elements 2006 attached to the exterior of the central shaft. Each cord element is attached to the exterior of the central shaft at two positions. These positions are spaced close together to define a loop. A plurality of loops is grouped into a line extending along the exterior of the central shaft, and a plurality of these lines of loops is spaced around the circumference of the exterior surface of the central shaft. Rotation of the cleaning element causes the cord elements to bow out from the central shaft, form complete loops and contact the surface of the structure to be cleaned. Suitable materials for the cord elements include synthetic, i.e., plastic, or natural fiber rope. In one embodiment, each cord is twisted for additional rigidity and improved biofouling removal.

Referring to FIG. 21, one embodiment of the cleaning element 2102 includes a central shaft 2104 and a plurality of lines of individual blades 2106 attached to the exterior of the central shaft. Each blade extends radially out from the exterior of the central shaft a desired distance. Each line extends along the exterior of the central shaft, and a plurality of these lines is spaced around the circumference of the exterior surface of the central shaft. Rotation of the cleaning element causes the blades to contact the surface of the structure to be cleaned. Suitable materials for the blades include plastic. In one embodiment the lengths of the blades in each line are varied, defining a profile that complements the profile of the surface of the structure to be cleaned.

Referring to FIGS. 22 and 23, in another exemplary embodiment of the biofouling removal mechanism 2200, the plurality of cleaning elements 2202 are a plurality of rotating brush elements disposed in a protective housing 2201 that allows the operator to mount the biofouling removal mechanism laterally in the direction of arrow D over the structure to be cleaned 2204. This protective housing prevents splatter of the biofouling being removed.

The biofouling removal mechanism includes a plurality of brush-cleaning elements 2202, each having a central shaft. A motor 2216 is provided in communication with the central shaft of each cleaning element to rotate that cleaning element relative to the surface of the structure to be cleaned. Suitable motors include hydraulic motors and electric motors. In one embodiment, the motor is an electric motor, and the biofouling removal mechanism includes a power supply 2210 in communication with the electric motor. The protective housing has an opening 2206 on one end that extends partially along either side of the protective housing. The opening is sized to accommodate passage of the structure to be cleaned 2204 into the protective housing, and the brush elements of the cleaning elements are flexible enough to facilitate passage over the structure to be cleaned. A plurality of rollers 2212 are provided to engage the structure to be cleaned, to maintain the desired alignment and spacing between the biofouling removal mechanism and the structure to be cleaned and to facilitate movement of the biofouling removal mechanism over the structure to be cleaned.

The motor rotates the cleaning elements relative to the surface of the structure to be cleaned. This removes biofouling and also provides propulsion of the biofouling removal mechanism along the structure to be cleaned. Therefore, the motor and brushes are cleaning elements and propulsion mechanisms. In one embodiment, screening is provided over the opening 2206 in the housing to further restrain any biofouling splatter. This screening is split or otherwise configured to allow passage of the structure to be cleaned. In one embodiment, the biofouling cleaning mechanism can include a water or liquid source 2208 in contact with a port 2209 in the protective housing. Water or other liquid is introduced through the port to flush or remove biofouling from the protective housing. Additional piping and nozzles can be included in the protective housing in communication with the port to provide the desired distribution and velocity of liquid within the protective housing.

Embodiments of the biofouling removal mechanism accommodate passage along an entire length of the structure to be cleaned without having to remove the biofouling removal mechanism, as the structure of the biofouling removal mechanism accommodates and passes all changes in geometry along the length of the structure to be cleaned. Therefore, the biofouling removal mechanism can be attached to the structure to be cleaned in situ, without having to move or position the structure or to select an accommodating location along the length of the structure to be cleaned. In particular, the biofouling removal mechanism can be attached at an end of the structure to be cleaned. When the structure to be cleaned is a seismic streamer, the biofouling removal mechanism is attached at the beginning of the streamer, e.g., on the lead-in, which connects the vessel to the first streamer sections. This eliminates the need to use separate work boats for launching the biofouling removal mechanism and facilitates cleaning in poor weather conditions and at night.

Referring to FIG. 24, one exemplary embodiment is directed to a method for removing biofouling from seismic equipment that has a changing geometry along its length and that is pulled by a towing vessel 2400. Suitable seismic equipment includes a seismic streamer including all sections of the seismic streamer and various locations along the length of the seismic streamer. The biofouling removal mechanism is attached to the seismic equipment 2402. Any arrangement of the biofouling removal mechanism disclosed herein can be used and attached to the seismic equipment. In one embodiment, the biofouling removal mechanism is attached to the seismic equipment from the towing vessel at a beginning of the seismic equipment located at the towing vessel. Therefore, no separate work or service boats are required, and the biofouling removal mechanism can be launched at any time of day in any kind of weather. Alternatively, the biofouling removal mechanism is attached from a service boat separate from the towing vessel while the seismic equipment is located below a surface of a body of water. Therefore, the service boats do not need to engage the seismic equipment and raise the seismic equipment from the water to attach the biofouling removal mechanism to the seismic equipment. This facilitates attachment of the biofouling removal mechanism on the seismic equipment closer to the towing vessel where tensional forces in the seismic equipment make lifting the seismic equipment above the surface of water difficult.

Having attached the biofouling removal mechanism to the seismic equipment, the structure of the biofouling removal mechanism is used to propel the biofouling removal mechanism along an entire length of the seismic equipment while removing biofouling and accommodating all changes in the geometry of the seismic equipment 2404. These changes in the geometry of the seismic equipment include changes in a diameter of the seismic equipment, joints, weights, floats, spreader ropes between streamer cables, ropes and chains used to attach floats, wings or radial projections. In one embodiment, using the structure of the biofouling removal mechanism includes rotating the biofouling removal mechanism having a helical structure to pass portions of the seismic equipment associated with the changing geometry through windings in the helical structure. Alternatively, using the structure of the biofouling removal mechanism includes expanding a folding structure of the biofouling removal mechanism to a size and shape sufficient to pass portions of the seismic equipment associated with the changing geometry through an expanded folding structure. For inflatable structures, using the structure of the biofouling removal mechanism involves inflating the inflatable structure of the biofouling removal mechanism to a size sufficient to pass portions of the seismic equipment associated with the changing geometry through an inflated inflatable structure. Using the structure of the biofouling removal mechanism also includes taking advantage of any of the other structural components of the biofouling removal mechanism as described above in order to achieve cleaning along an entire length of the seismic equipment.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A biofouling removal mechanism comprising:
at least one cleaning element configured to remove accumulated biofouling from a structure; and
a cleaning element support structure attached to the cleaning element, the cleaning element support structure configured to guide the cleaning element along the structure and to accommodate changes in a geometry of the structure as the cleaning element passes along the structure.

2. The biofouling removal mechanism of claim 1, wherein the cleaning element comprises an edge tool.

3. The biofouling removal mechanism of claim 1, wherein the cleaning element comprises a plurality of circular cleaning scrapers arranged co-axially, and each one of the circular cleaning scrapers comprises a unique diameter.

4. The biofouling removal mechanism of claim 1, wherein the cleaning element comprises a leading edge configured to curve away from the structure to guide the cleaning element over changes in the size and shape of the structure.

5. The biofouling removal mechanism of claim 1, wherein the cleaning element support structure comprises a protective element to prevent contact between the cleaning element and the structure and to establish a pre-defined spacing between the cleaning element and the structure.

6. The biofouling removal mechanism of claim 5, wherein the protective element comprises a plurality of parallel lines spaced from each other and extending in a direction in which the cleaning element passes over the structure.

7. The biofouling removal mechanism of claim 1, wherein the cleaning element support structure comprises a biasing member to bias the cleaning element toward the structure.

8. The biofouling removal mechanism of claim 1, wherein the cleaning element support structure comprises:
a helical structure, the cleaning element disposed in an interior of the helical structure; and
at least one strut in contact with the helical structure and the cleaning element to position the cleaning element in the interior of the helical structure.

9. The biofouling removal mechanism of claim 1, wherein the cleaning element support structure comprises a foldable structure having a folded position for attachment to the biofouling removal mechanism to the structure and an expanded position to accommodate the changes in the geometry of the structure.

10. The biofouling removal mechanism of claim 1, wherein the cleaning element support structure comprises an inflatable structure.

11. The biofouling removal mechanism of claim 1, wherein the cleaning element support structure comprises at least one of ballast, a buoy and a propulsion mechanism to drive the biofouling removal mechanism along the structure, and the propulsion mechanism comprising at least one of a drag canopy and a propulsion motor.

12. The biofouling removal mechanism of claim 1, wherein the cleaning element support structure comprises a cleaning element motor in communication with the cleaning element to move the cleaning element relative to the cleaning element support structure.

13. The biofouling removal mechanism of claim 1, wherein the cleaning element support structure comprises:
a hollow conical housing comprising a plurality of sections, the cleaning element attached to an interior of the hollow conical housing; and
at least one elastic band passing completely around the hollow conical housing on an exterior of the hollow conical housing opposite the interior.

14. A method for removing biofouling from seismic equipment, the method comprising:
attaching a biofouling removal mechanism to the seismic equipment; and
using a structure of the biofouling removal mechanism to propel the biofouling removal mechanism along an entire length of the seismic equipment while removing biofouling and accommodating all changes in a geometry of the seismic equipment.

15. The method of claim 14, wherein attaching the biofouling removal mechanism further comprises attaching the biofouling removal mechanism at a towing vessel that is pulling the seismic equipment.

16. The method of claim 14, wherein attaching the biofouling removal mechanism further comprises attaching the biofouling removal mechanism from a service boat separate from a towing vessel that is pulling the seismic equipment with the seismic equipment located below a surface of a body of water.

17. The method of claim 14, wherein the changes in the geometry of the seismic equipment comprise changes in a diameter of the seismic equipment, joints, weights, floats, spreader ropes between streamer cables, ropes and chains used to attach floats, wings or radial projections.

18. The method of claim 14, wherein using a structure of the biofouling removal mechanism further comprises rotating the biofouling removal mechanism having a helical structure to pass portions of the seismic equipment associated with the changes in the geometry of the seismic equipment through windings in the helical structure.

19. The method of claim 14, wherein using a structure of the biofouling removal mechanism further comprises expanding a folding structure of the biofouling removal mechanism to a size and shape sufficient to pass portions of the seismic equipment associated with the changes in the geometry of the seismic equipment through an expanded folding structure.

20. The method of claim 14, wherein using a structure of the biofouling removal mechanism further comprises inflating an inflatable structure of the biofouling removal mechanism to a size sufficient to pass portions of the seismic equipment associated with the changes in the geometry of the seismic equipment through an inflated inflatable structure.
